(19) United States
(12) Patent Application Publication
(10) Pub. No.: US 2025/0299659 A1
(43) Pub. Date: Sep. 25, 2025

(54) INFORMATION PROCESSING APPARATUS, METHOD, AND PROGRAM

(71) Applicant: CASIO COMPUTER CO., LTD., Tokyo (JP)

(72) Inventors: Masaru SETOGUCHI, Tokyo (JP); Mitsuhiro MATSUMOTO, Tokyo (JP)

(73) Assignee: CASIO COMPUTER CO., LTD., Tokyo (JP)

(21) Appl. No.: 19/086,281

(22) Filed: Mar. 21, 2025

(30) Foreign Application Priority Data
Mar. 22, 2024 (JP) 2024-045801

(51) Int. Cl. G10H 1/36

(52) U.S. Cl. CPC G10H 1/366; G10H 2210/066

(57) ABSTRACT

To increase the number of candidate pitches, an information processing apparatus includes at least one processor. The at least one processor is configured to set a pitch of a musical tone in a sounding period on music data as a first candidate pitch, and set a second candidate pitch on a basis of the first candidate pitch, detect an operated pitch associated with a manipulation element operated by a user, and on a basis of the detected operated pitch, select a sounding pitch of the musical tone from among a plurality of candidate pitches including the first and second candidate pitches, and instruct a speaker to sound the musical tone with the selected sounding pitch.

### CROSS-REFERENCE TO RELATED APPLICATIONS

This application is based upon and claims the benefit of priority under 35 USC 119 of Japanese Patent Application JP 2024-045801 filed Mar. 22, 2024, the entire disclosure of which, including the description, claims, drawings, and abstract, is incorporated herein by reference in its entirety.

### BACKGROUND OF THE INVENTION

### 1. Field of the Invention

The disclosure herein relates to information processing apparatuses, methods, and programs.

### 2. Related Art

An apparatus for assisting the user's operation to play a musical instrument is known. Japanese Unexamined patent Application Publication No. 2008-20875 (Patent Document 1), for example, describes an apparatus that sets the pitch of a musical tone whose sounding is specified by the music data as a candidate pitch. In response to a user's performance operation, this apparatus produces a musical tone of the set candidate pitch.

The apparatus of Patent Document 1 sets only the pitch of the musical tone whose sounding is specified by the music data as a candidate pitch, depending on the sounding status of the musical tone. The apparatus of Patent Document 1 has room for improvement in terms of increasing the number of candidate pitches.

In view of the above, the present disclosure aims to provide an information processing apparatus, a method and a program capable of increasing the number of candidate pitches.

### SUMMARY OF THE INVENTION

According to one aspect of the present disclosure, an information processing apparatus includes at least one processor. The at least one processor is configured to set a pitch of a musical tone in a sounding period on music data as a first candidate pitch, and set a second candidate pitch on a basis of the first candidate pitch, detect an operated pitch associated with a manipulation element operated by a user, on a basis of the detected operated pitch, select a sounding pitch of the musical tone from among a plurality of candidate pitches including the first and second candidate pitches, and instruct a speaker to sound the musical tone with the selected sounding pitch.

According to another aspect of the present disclosure, a method makes a computer execute the following steps of: setting a pitch of a musical tone in a sounding period on music data as a first candidate pitch, and setting a second candidate pitch on a basis of the first candidate pitch, detecting an operated pitch associated with a manipulation element operated by a user, on a basis of the detected operated pitch, selecting a sounding pitch of the musical tone from among a plurality of candidate pitches including the first and second candidate pitches, and instructing a speaker to sound the musical tone with the selected sounding pitch.

According to another aspect of the present disclosure, a storage medium has stored thereon a computer program that makes a computer execute the following steps of: setting a pitch of a musical tone in a sounding period on music data as a first candidate pitch, and setting a second candidate pitch on a basis of the first candidate pitch; detecting an operated pitch associated with a manipulation element operated by a user; and on a basis of the detected operated pitch, selecting a sounding pitch of the musical tone from among a plurality of candidate pitches including the first and second candidate pitches, and instructing a speaker to sound the musical tone with the selected sounding pitch.

These aspects of the present disclosure provide an information processing apparatus, a method and a program capable of increasing the number of candidate pitches.

### BRIEF DESCRIPTION OF THE DRAWINGS

FIG. 1 is a block diagram showing the configuration of a musical instrument system in accordance with one embodiment of the present disclosure.

FIG. 2 describes an overview of the information processing apparatus, method, and program according to one embodiment of the present disclosure.

FIG. 3 shows how to set a plurality of candidates notes to be sounded in one embodiment of the present disclosure.

FIG. 4 shows how to set a plurality of candidates notes to be sounded in one embodiment of the present disclosure.

FIG. 5 shows how to set a plurality of candidates notes to be sounded in one embodiment of the present disclosure.

FIG. 6 shows the relationship between a plurality of candidate notes to be sounded and the sounding period of a musical tone in one embodiment of the present disclosure.

FIG. 7 is a flowchart of the process performed by a processor in an information processing apparatus in one embodiment of the present disclosure.

FIG. 8A describes a subroutine for the music progression process in step S104 in FIG. 7.

FIG. 8B describes a subroutine for the music progression process in step S104 in FIG. 7.

FIG. 9A describes a subroutine for the performance operation process in step S105 in FIG. 7.

FIG. 9B describes a subroutine for the performance operation process in step S105 in FIG. 7.

FIG. 9C describes a subroutine for the performance operation process in step S105 in FIG. 7.

FIG. 10A describes a subroutine for the event process in modified example 1 of the present disclosure.

FIG. 10B describes a subroutine for the event process in modified example 1 of the present disclosure.

FIG. 11 shows an example of a chord table according to modified example 1 of the present disclosure.

FIG. 12A describes a subroutine for the music progression process according to modified example 2 of the present disclosure.

FIG. 12B describes a subroutine for the music progression process according to modified example 2 of the present disclosure.

FIG. 12C describes a subroutine for the music progression process according to modified example 2 of the present disclosure.

FIG. 13 shows the relationship between the sounding period of a musical tone and the storage period of the corresponding note number in modified example 2 of the present disclosure.

### DESCRIPTION OF THE PREFERRED EMBODIMENTS

The following description relates to an information processing apparatus, a method, and a program according to one embodiment of the present disclosure. Like numbers indicate like components throughout the drawings, and their duplicated descriptions are simplified or omitted as appropriate.

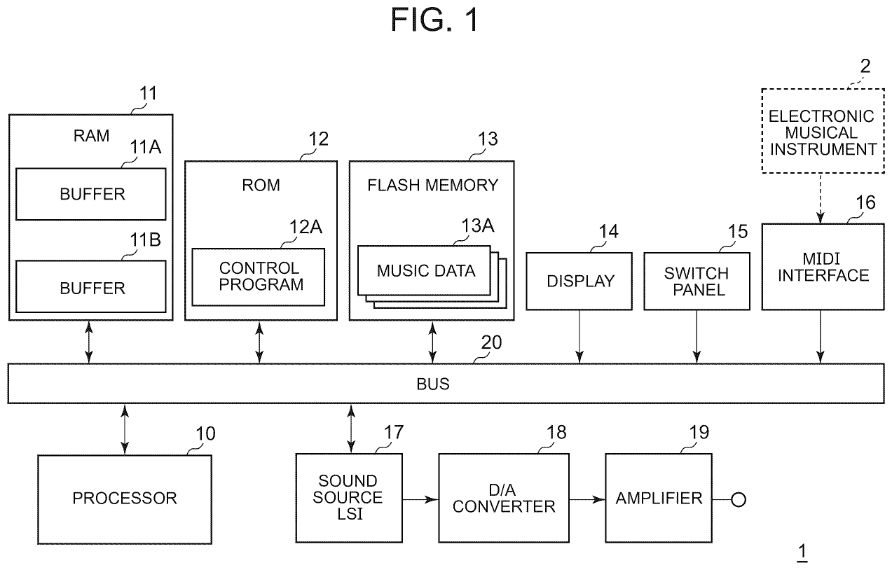

As shown in FIG. 1, a musical instrument system according to one embodiment of the present disclosure includes an information processing apparatus 1 and an electronic musical instrument 2. The information processing apparatus 1 and the electronic musical instrument 2 are connected to be communicable with each other via wire or wirelessly.

The information processing apparatus 1 is dedicated to electronic musical instruments equipped with a sound source. The information processing apparatus 1 may be replaced by other apparatuses such as a smartphone, a tablet terminal, a personal computer (PC), and a game controller. For instance, a smartphone or a tablet terminal is operable as the information processing apparatus 1 by downloading an application for executing various processes according to one embodiment of the present disclosure from an app store and installing it. In this case, the user is allowed to operate the information processing apparatus 1 by performing a touch operation on a graphical user interface (GUI) screen, on which various components are laid out.

The electronic musical instrument 2 is an example of an apparatus for musical performance. For instance, the electronic musical instrument 2 is an electronic keyboard. The electronic musical instrument 2 may be an electronic keyboard instrument such as an electronic piano, other than an electronic keyboard. The electronic musical instrument 2 may be another form of electronic musical instrument, such as an electronic percussion instrument, an electronic wind instrument, or an electronic string instrument.

The keyboard of the electronic musical instrument 2 is equipped with 88 keys, which are an example of manipulation elements for musical performance (hereinafter simply called manipulation elements). That is, the electronic musical instrument 2 is an example of a musical-performance apparatus equipped with a plurality of manipulation elements. The manipulation elements are also called keys. Each key is associated with a different pitch from A0 to C8.

In this disclosure, the international notation will be used for description, with pitch C4 being note number 60. Therefore, the note numbers corresponding to the pitches A0 to C8 are 21 to 108. A pitch may be called a note. Note numbers may be called key numbers or musical instrument digital interface (MIDI) keys. The number of keys on a keyboard is not limited to 88. The number of keys may be 61 or 76, for example.

Pitch names represent the absolute pitch, and are specifically written as C, C♯, D, D♯, E, F, F♯, G, G♯, A, A♯, and B. These pitch names C to B may be expressed as pitch name numbers 0 to 11, respectively.

The electronic musical instrument 2 outputs MIDI data to the information processing apparatus 1 in response to a performance operation by a user. Hereinafter, this MIDI data will be referred to as “MIDI data D”. The MIDI data D output from the electronic musical instrument 2 includes various messages such as note-on, note-off, and control change.

In another embodiment, a musical instrument app that reproduces the electronic musical instrument 2 may be installed in the information processing apparatus 1. In this case, the user is allowed to perform music-performance operations on the musical instrument app instead of with the electronic musical instrument 2. In yet another embodiment, the information processing apparatus 1 may be built into the electronic musical instrument 2. In this case, the information processing apparatus 1 may be an element of the electronic musical instrument 2.

The information processing apparatus 1 is an example of a computer. As shown in FIG. 1, the information processing apparatus 1 has a hardware configuration including a processor 10, a random access memory (RAN) 11, a read only memory (ROM) 12, a flash memory 13, a display 14, a switch panel 15, a MIDI interface 16, a sound source large scale integration (LSI) 17, a D/A converter 18, and an amplifier 19. These various components of the information processing apparatus 1 are connected via a bus 20.

The processor 10 reads out programs and data stored in the ROM 12. The processor 10 uses the RAM 11 as a work area to comprehensively control the information processing apparatus 1.

For instance, the processor 10 may be a single processor or a multi-processor, and includes at least one processor. When the processor 10 includes multiple processors, it may be packaged as a single device, or may be configured as multiple devices that are physically separated within the information processing apparatus 1. For instance, the processor 10 may be called a control unit, a central processing unit (CPU), a microprocessor unit (MPU) or a micro controller unit (MCU).

The RAM 11 temporarily stores data and programs. The RAM 11 holds various data such as various programs, music data, and waveform data read from the ROM 12, for example. Some memory areas of the RAM 11 are reserved as a buffer 11A and a buffer 11B. As described in detail below, the buffers 11A and 11B store a note number of a candidate note to be sounded (candidate note number), a note number associated with a key pressed by the user (pressed note number), and a note number of the musical tone being sounded (sounded note number), for example.

The ROM 12 stores a control program 12A. The processor 10 executes the control program 12A to execute various processes according to one embodiment of the present disclosure.

The flash memory 13 stores a plurality of pieces of music data 13A. These pieces of music data 13A are data for different songs. For convenience, however, they are given the same reference number 13A. For instance, the music data 13A is created in a standard MIDI file (SMF) format. The music data 13A includes a plurality of events. The events include a delta time, a command type, and command data written therein. That is, the music data 13A includes a plurality of events (an example of information on a plurality of musical tones that constitute a song), each of which is associated with a sounding timing.

The command type is information such as note-on, note-off, control change, pitch bend change, and expression. In the MIDI standard, this is called a status byte. The command data is configuration information for the command indicated by the command type. The command data includes information such as a note number and velocity. In the MIDI standard, this is called a data byte.

The processor 10 sequentially reads the events in the music data 13A and progresses the music according to the delta time described in each event. The music data 13A is not limited to those stored in the flash memory 13. For instance, the music data 13A may be obtained via a universal serial bus (USB) memory, via the internet, or via a smartphone.

For instance, the display 14 includes a liquid crystal display (LCD) and an LCD controller. When the LCD controller drives the LCD in accordance with the control signal from the processor 10, a screen corresponding to the control signal is displayed on the LCD. The LCD may be configured as a touch panel display. The LCD may be replaced by other forms of displays, such as organic electro luminescence (EL) or light emitting diode (LED).

The switch panel 15 includes a plurality of switches and buttons for the user to perform various operations. For instance, the switch panel 15 includes a power switch, a volume knob, a button for the user to select a song, a button for the user to select a performing part to be played, a button for the user to start playing a song, and a button for the user to stop playing a song.

The MIDI interface 16 connects the information processing apparatus 1 and the electronic musical instrument 2 so that they are communicable with each other. For instance, the MIDI interface 16 receives an input that is MIDI data output by the electronic musical instrument 2.

For instance, the ROM 12 stores the waveform data. The waveform data is loaded into the RAM 11 during the startup process of the information processing apparatus 1 so that the musical tones are promptly produced according to the music data 13A. The processor 10 instructs the sound source LSI 17 to read out the corresponding waveform data from the waveform data loaded in the RAM 11.

The sound source LSI 17 produces musical tones based on the waveform data read from the RAM 11 under the control of the processor 10. The sound source LSI 17 includes a plurality of generator sections. The sound source LSI 17 is capable of simultaneously producing musical tones in number up to the number of generator sections. In this embodiment, the processor 10 and the sound source LSI 17 are configured as separate processors. In another embodiment, the processor 10 and the sound source LSI 17 may be configured as a single processor.

Digital musical tone data generated by the sound source LSI 17 is converted into an analog signal by the D/A converter 18, and then amplified by the amplifier 19 and output from a line-out terminal, for example. For instance, a speaker is connected to the line-out terminal, and it plays the musical tones.

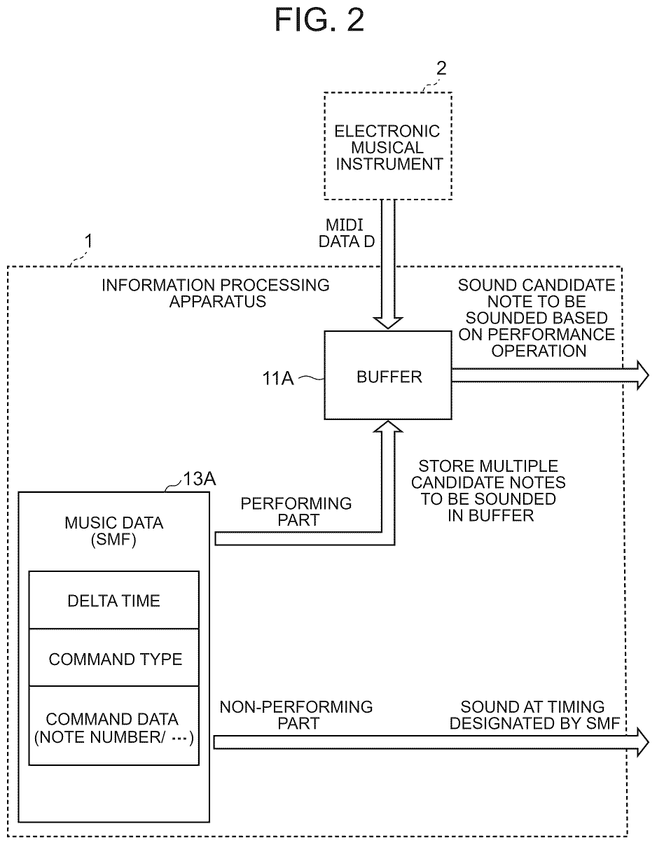

Referring to FIG. 2, the following describes an overview of the information processing apparatus, method, and program according to one embodiment of the present disclosure. An SMF (i.e., music data 13A) is made up of one or more tracks and includes multiple parts. The multiple parts include a piano part, a guitar part, a bass part, a soprano saxophone part, a drum part, an obbligato part, a chord part, and others. The user is allowed to select one performing part among these parts by operating the switch panel 15. For convenience, parts other than the performing part are described as “non-performing parts.”

In this embodiment, the chord data is a chord-name character string described in a meta event, for example. The chord-name character string is text data indicating the chords such as C, CM7, and Cm7. A meta event that includes a chord-name character string is referred to as a “chord event.” The chord data may be data of a chord part.

The music data 13A may include only one part. In this case, this one part is selected as the performing part.

The information processing apparatus 1 sequentially reads each event (MIDI data) included in the music data 13A. When the timing designated by the SMF for producing a musical tone of a non-performing part arrives, the information processing apparatus 1 immediately instructs the sound source LSI 17 to produce the musical tone designated by the event. That is, the information processing apparatus 1 automatically performs the musical tones of the non-performing part at the timing and volume (velocity) specified by the SMF. The velocity can be a value indicating the strength of a key depression, and also a value indicating the loudness (volume) of a musical tone.

For the performing part, the information processing apparatus 1 does not instruct the sound source LSI 17 to produce musical tones according to the SMF. When the timing designated by the SMF for producing a musical tone of the performing part arrives, the information processing apparatus 1 does not instruct the sound source LSI 17 immediately to produce the musical tone, but sets a plurality of candidate notes to be sounded on the basis of a note number described in the event. The information processing apparatus 1 stores the note numbers of the plurality of set candidates note to be sounded in the buffer 11A. The data in the buffer 11A is overwritten and stored as needed with a plurality of candidate notes to be sounded, as the song progresses.

Specifically, the information processing apparatus 1 stores the note numbers of a plurality of candidate notes to be sounded in the buffer 11A at the timing when a musical tone starts to be produced in accordance with a note-on event. The information processing apparatus 1 deletes the note numbers of these candidate notes to be sounded from the buffer 11A at the timing of muting the musical tone in accordance with a note-off event. That is, the information processing apparatus 1 stores the note numbers of the plurality of candidate notes to be sounded in the buffer 11A from the starting timing of a musical tone in accordance with a note-on event and the muting timing in accordance with a note-off event (an example of a sounding period on the music data).

While a user performs a musical operation with the electronic musical instrument 2, MIDI data D is input to the information processing apparatus 1. For instance, when MIDI data D including a note-on message is input, the information processing apparatus 1 selects one note number from among the note numbers of the plurality of candidate notes to be sounded that are stored in the buffer 11A at that time, regardless of the note number included in the MIDI data D. For instance, the information processing apparatus 1 selects the note number that is closest to the note number included in the MIDI data D (i.e., the pressed note number that is associated with the key pressed by the user). The information processing apparatus 1 instructs the sound source LSI 17 to produce the musical tone with the selected note number. The volume of the musical tone to be sounded is determined according to the velocity included in the MIDI data D, not the velocity described in the event of the music data 13A. That is, the information processing apparatus 1 produces a musical tone of a pitch selected from the plurality of candidate notes to be sounded at the timing and volume of a user operation.

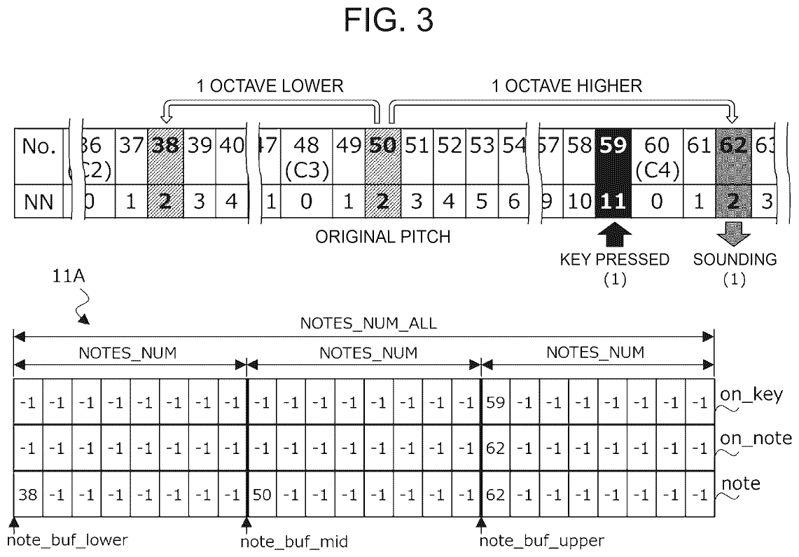

Referring to FIG. 3 to FIG. 5, the following describes how to set a plurality of candidates notes to be sounded. FIG. 3 through FIG. 5 show a correspondence table between note numbers (No.) and pitch name numbers (NN) in a key range that is a part of the keyboard of the electronic musical instrument 2. In this correspondence table, hatching (for convenience, called “hatching of a first pattern”) is placed on the note numbers (candidate note numbers) and pitch name numbers of the candidate notes to be sounded. The note number (pressed note number) and pitch name number of the operated pitch are shown in black. The note number (sounding note number) and pitch name number of the sounding pitch are given a second pattern of hatching that is different from the first pattern of hatching.

The table is further marked with the words “key pressed (n)” together with an arrow indicating the pressed note number. The word “sounding (n)” is also attached, together with an arrow indicating the key that corresponds to the sounded note number of the musical tone that is sounded by the key pressing operation, where n is a natural number that indicates the key pressing order (the order of keys currently pressed by the user) and the sounding order of the corresponding musical tones.

The length of each arrow indicates the velocity. The shorter the arrow, the smaller the velocity at which the key is pressed, and the corresponding velocity at which the sound is produced (such as the volume of the sound) also becomes smaller. The longer the arrow, the greater the velocity at which the key is pressed, and the corresponding velocity at which the sound is produced (such as the volume of the sound) also becomes greater.

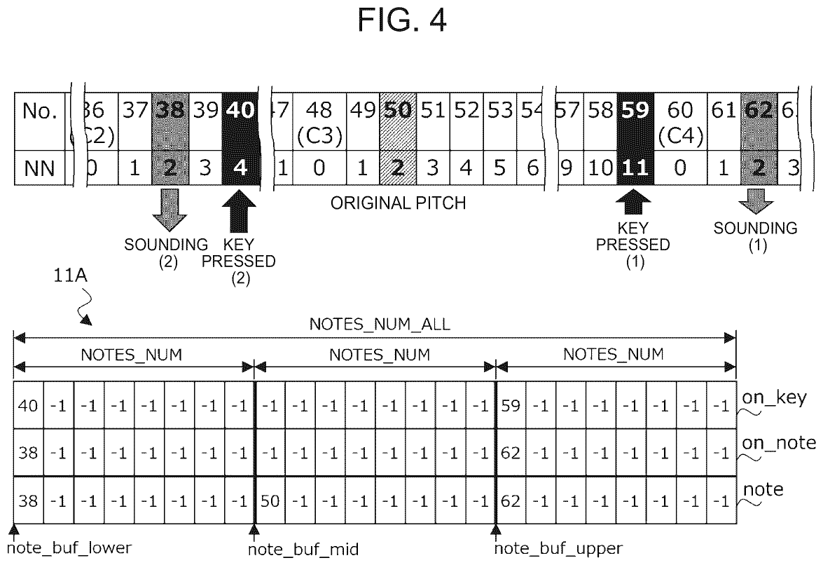

The buffer 11A is allocated as an array in the RAM 11. FIG. 3 and FIG. 4 also show a conceptual diagram of the buffer 11A as an array. The data type of buffer 11A includes note, on_note, and on_key as member variables. The note member stores a candidate note number indicating the pitch of the candidate note to be sounded (an example of a first candidate pitch and a second candidate pitch). The on_note member stores a sounding note number (an example of a sounding pitch) that indicates the pitch of the musical tone to be sounded. The on_key member stores the pressed note number (an example of the operated pitch associated with a manipulation element operated by the user). For elements where a note number has not been stored, the value −1 is stored. The buffer 11A (note_buf[24]) is allocated in the RAM 11 in the form of an array of variables of this data type. The number of elements in the array is 24. The element number 24 is noted as “NOTES_NUM_ALL.”

As shown in FIG. 3 and FIG. 4, the buffer 11A is allocated in a continuous area on the RAM 11. This continuous area is partitioned into three regions, each with eight elements. The element number 8 is noted as “NOTES_NUM.” Starting from the top of the continuous area, the pointer variables for these regions are written as “note_buf_lower”, “note_buf_mid”, and “note_buf_upper”. For convenience, the region of the first eight elements in the continuous area is marked as “region_note_buf_lower”. The region of the following eight elements is marked as “region_note_buf_mid”. The region of eight more elements to follow is marked “region_note_buf_upper”.

FIG. 3 shows an example where a note-on event of pitch D3 (note number 50) occurs in the performing part and then the user presses the key of pitch B3 (note number 59) (see key pressed (1)).

The processor 10 sets the note number 50 described in the note-on event of the performing part as a candidate note number (an example of a first candidate pitch). The note number 50 indicates an example of the pitch (original pitch) of a musical tone that is in a sounding period on the data of the performing part determined in response to a user operation. The processor 10 further sets a second candidate pitch on the basis of the original pitch (an example of the first candidate pitch). In the example of FIG. 3, the processor 10 sets the note numbers of the pitch one octave higher (note number 62) and one octave lower (note number 38) of the original pitch (note number 50) as candidate note numbers (an example of a second candidate pitch based on the first candidate pitch). In other words, the processor 10 adds candidate pitches that are the pitches musically in harmony with the original pitch of the performing part.

For instance, pitches that are m octaves higher or lower of the original pitch (m is a natural number greater than or equal to 2) are also musically in harmony with the original pitch. Therefore, the processor 10 may set a note number that is m octaves higher or lower of the original pitch as a candidate note number, instead of or in addition to one octave higher or lower of the original pitch. In this manner, the processor 10 sets, as a candidate pitch, the pitch (an example of a second candidate pitch) an octave (or octaves) away from the original pitch (an example of a first candidate pitch).

It is noted that any reference to an element using a designation such as “first” and “second” in this disclosure does not generally limit the quantity or order of those elements. These designations are used for convenience to distinguish between two or more elements. Thus, reference to first and second elements does not imply, for example, that only two elements are used and that the first element must precede the second element.

The processor 10 selects, from among the set candidate pitches, the candidate pitch closest to the operated pitch (i.e., the candidate note number having the smallest absolute difference value from the pressed note number) as the sounding pitch (i.e., the sounding note number). If there are two candidate note numbers with the same absolute difference value from the pressed note number, the processor 10 selects the lower candidate note number as the sounding note number. In the example of FIG. 3, the candidate note numbers 38, 50, and 62 have the absolute difference values of 21, 9 and 3 from the pressed note number 59, respectively. Thus, the processor 10 selects the candidate note number 62 with the smallest absolute difference value from the pressed note number 59 as the sounding note number.

The processor 10 instructs the sound source LSI 17 to produce the musical tone of the selected sounding note number 62 at the velocity at which the key is pressed. This causes the musical tone with the sounding note number 62 to be produced (see sounding (1)). The user is allowed to play the part they want to play at any timing and volume while letting the song automatically progress and listening to the musical tones of the non-performing part(s). No matter what keyboard operation is performed, the performing part is produced with a musical tone that is musically in harmony with the original pitch.

In this manner, the processor 10 detects the pressed note number (an example of an operated pitch associated with a manipulation element operated by a user). Then, on the basis of the detected pressed note number, the processor 10 selects, as the sounding pitch, a candidate pitch that is not the pitch of the musical tone being sounded and is closest to the operated pitch from among a plurality of candidate pitches including the first candidate pitch and the second candidate pitch. The processor 10 processes the sounding of this sounding pitch so that the pitch is sound at a volume corresponding to the velocity (an example of a value indicating the strength of an operation on a manipulation element) at the time of key depression.

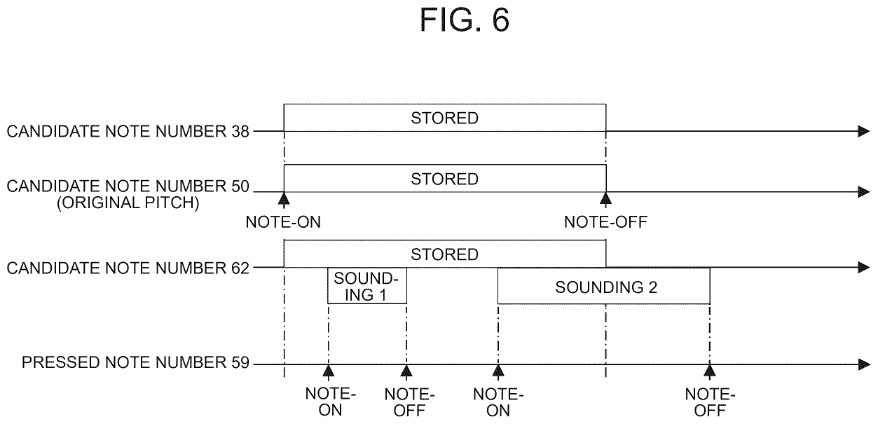

Referring to FIG. 6, the following describes the example of FIG. 3 in more details. FIG. 6 shows the relationship between the period during which each candidate note number is stored in the buffer 11A (i.e., the sounding period of the musical tone on the music data 13A) and the sounding period of musical tone corresponding to key depression and key release.

When a note-on event of pitch D3 (note number 50) occurs in the performing part, the processor 10 stores three candidate note numbers in the buffer 11A.

Specifically, the processor 10 stores note number 50 of the original pitch in the note member of an empty element in the region note_buf_mid of the buffer 11A; the processor 10 stores note number 62 of the pitch one octave higher of the original pitch in the note member of an empty element in the region note_buf_upper; and the processor 10 stores note number 38 of the pitch one octave lower of the original pitch in the note member of an empty element in the region note_buf_lower (see FIG. 3 and FIG. 6).

When a note-on event corresponding to a key depression is input, the processor 10 stores the pressed note number 59 in the on_key member of the corresponding element. Specifically, the processor 10 stores the pressed note number 59 in the on_key member of the element of the region note_buf_upper that corresponds to the candidate note number 62 that is closest to the pressed note number 59. Furthermore, the processor 10 stores the sounding note number 62 in the on note member of the same element and instructs the sound source LSI 17 to produce the musical tone of the sounding note number 62 (see FIG. 3). This causes the musical tone with the sounding note number 62 to be produced (see sounding (1) in FIG. 6).

When a note-off event corresponding to a key release operation is input, the processor 10 changes the pressed note number 59 stored in the on_key member of the same element to value −1. The processor 10 changes the sounding note number 62 in the on note member of the same element to value −1 and instructs the sound source LSI 17 to mute the musical tone of the sounding note number 62. This causes the musical tone with the sounding note number 62 to be muted, even though the musical tone of the original pitch in the music data 13A is still in the sounding period (see sounding (1) in FIG. 6).

When a note-off event of pitch D3 (note number 50) occurs in the performing part, the processor 10 changes all the values of candidate note numbers 38, 50, and 62 stored in the note members of the elements in the corresponding regions to value −1. However, the processor 10 does not change the values stored in the on note and on_key members. These values are changed to value −1 when the note-off event corresponding to the key release operation is entered. Thus, even when the sounding period of the musical tone with the original pitch has ended in the music data 13A, sounding of the musical tone of the sounding note number 62 continues until the key release operation is performed (see sounding 2 in FIG. 6).

In this way, regardless of whether or not a musical tone of the original pitch (an example of a first candidate pitch) is in sounding period on the music data 13A, when a key release operation is performed (when the user stops operation to the manipulation element), the corresponding sounding pitch is muted. Regardless of whether or not a musical tone of the original pitch is in a sounding period on the music data 13A, if no key release operation is performed (i.e., if the user keeps the operation to the manipulation element), the sounding of the corresponding sounding pitch will continue. This allows the user to play the performing part with a musical tone that reflects their intention.

FIG. 4 shows an example where a note-on event of pitch D3 (note number 50) occurs in the performing part and then the user further presses the key of pitch E2 (note number 40) (see key pressed (2)).

The processor 10 selects, as the sounding note number, the candidate note number 38 that is closest to the pressed note number 40 from among the unsound candidate note numbers. The buffer 11A stores the pressed note number 40 in the on_key member of the element of the region note_buf_lower corresponding to the candidate note number 38, and also stores the sounding note number 38 in the on note member of the same element. The processor 10 instructs the sound source LSI 17 to produce the musical tone of the sounding note number 38 at the velocity at which the key is pressed. This causes the musical tone with the sounding note number 38 to be produced (see sounding (2)).

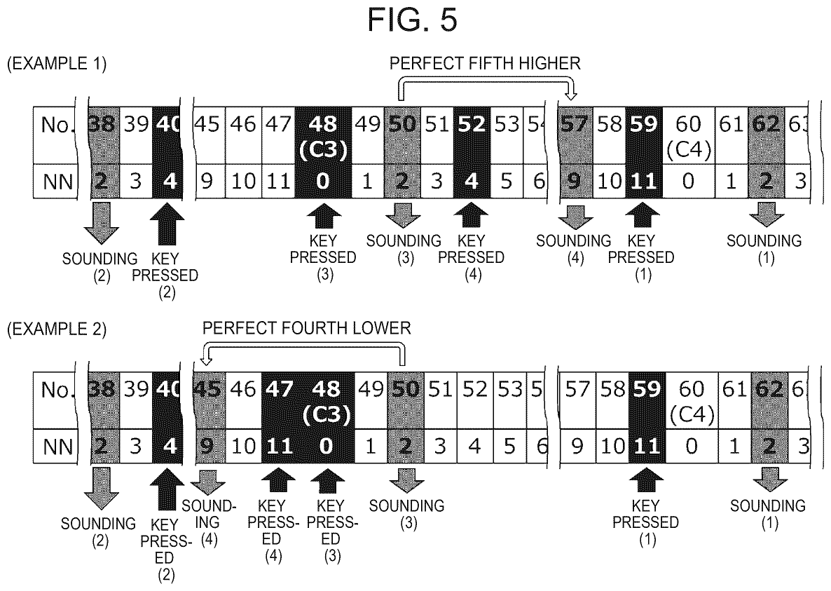

FIG. 5 shows an example (Example 1) where a note-on event of pitch D3 (note number 50) occurs in the performing part and then the user further presses the keys of pitch C3 (note number 48) and pitch E3 (note number 52) (see key pressed (3) and key pressed (4)). FIG. 5 shows an example (Example 2) where a note-on event of pitch D3 (note number 50) occurs in the performing part and then the user further presses the keys of pitch C3 (note number 48) and pitch B2 (note number 47) (see key pressed (3) and key pressed (4)).

In (Example 1) and (Example 2) of FIG. 5, the processor 10 selects, as the sounding note number, the candidate note number 50 that is closest to the pressed note number 48 from among the unsound candidate note numbers. The processor 10 instructs the sound source LSI 17 to produce the musical tone of the selected sounding note number 50 at the velocity at which the key is pressed. This causes the musical tone with the sounding note number 50 to be produced (see sounding (3)), and thus the musical tones of all of the candidate pitches (candidate note numbers 38, 50, and 62) are now being sounded.

In (Example 1) and (Example 2) of FIG. 5, when the key with pitch E3 (note number 52) is pressed, all candidate note numbers are being sounded. Thus, the processor 10 selects the note number that is a perfect fifth higher of the candidate note number (i.e., note number 57) or a perfect fourth lower of the candidate note number (i.e., note number 45) as new candidate note numbers and selects the sounding note numbers. In (Example 1) in FIG. 5, the processor 10 sets the note number 57 (pitch that is perfect fifth higher) that is closer to the pressed note number 52 as a candidate note number, and uses this as the sounding note number. In (Example 2) in FIG. 5, the processor 10 sets the note number 45 (pitch that is perfect four lower) that is closer to the pressed note number 47 as a candidate note number, and uses this as the sounding note number.

In this embodiment, pitches a perfect fifth higher or a perfect fourth lower of the candidate pitches (the original pitch and pitches one octave higher or lower of the original pitch) are referred to as “pitches of perfect intervals”. Pitches that are a perfect fifth higher or a perfect fourth lower of the pitch m octaves higher or lower of the original pitch (m is a natural number greater than or equal to 2) are also referred to as “pitches of perfect intervals.” A pitch of perfect interval is an example of a third candidate pitch. Note that if there are multiple original pitches, the pitches of perfect intervals corresponding to these original pitches may have a small pitch difference. If such musical tones with a small pitch difference are sounded, dissonance may occur. Thus, only when there is one musical tone (i.e., one original pitch) during the sounding period on the music data 13A, a note number that is a perfect fifth higher or a perfect fourth lower is set as a candidate note number.

When pitches that are an octave apart are set as candidate pitches, each original pitch is simply shifted by one octave. In this case, therefore, when there are multiple original pitches, setting octave-apart pitches as candidate pitches does not cause problems of dissonance.

This embodiment sets a larger number of candidate pitches than the number of original musical tones included in the music data 13A, and then selects the sounding pitch. This avoids a shortage of candidate pitches when selecting a musical tone to be sounded in response to a key pressing operation. Furthermore, pitches of musical tones that are in musical harmony with the original pitch are set as candidate pitches. Thus, no matter what keyboard operation is performed, the performing part is produced with a musical tone that is musically in harmony with the original pitch. Users who are not good at playing musical instruments also are able to enjoy the performance.

The candidate note numbers in the buffer 11A are automatically replaced according to a note-on event and note-off event included in the performing part. Therefore, the user is able to freely play the electronic musical instrument 2 and still play the song with the musically appropriate notes that are to be sounded at that moment.

In this embodiment, a musical tone of a candidate note number that is closest to the pressed note number is sounded from among the plurality of candidate note numbers. The user is allowed to, to some extent, determine the pitch of a musical tone to be sounded depending on which key is pressed. That is, even if the user performs any keyboard operation, they are allowed to play the performing part with the musical tones that reflect their intention.

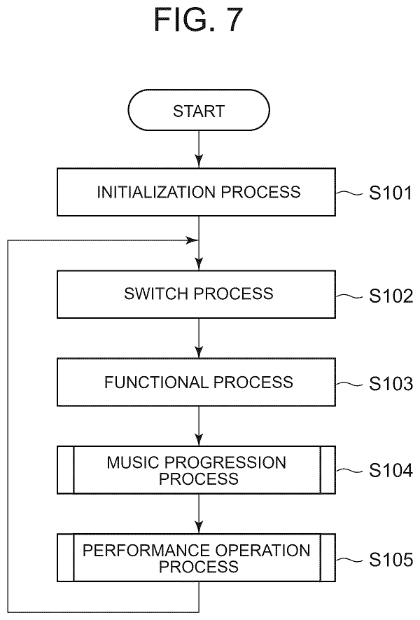

Also when the user presses multiple keys simultaneously, the process is executed in the ascending order of pressed note numbers, for example, and the sounding note numbers are selected one by one. The process of the flowchart described later (the process of steps S102 to S105 in FIG. 7, including determination of the target to be sounded and sounding instruction) is executed periodically, for example, every 1 ms. This means that a sounding note number is selected each time 1 ms elapses, and the musical tone of the selected sounding note number is sounded sequentially each time 1 ms elapses. That is, when a user presses multiple keys simultaneously, the same number of musical tones as the number of pressed keys are sounded substantially simultaneously so that they are musically in harmony with each other.

FIG. 7 is a flowchart showing the process executed by the processor 10 in one embodiment of the present disclosure. For instance, when the information processing apparatus 1 is powered on, the execution of the process shown in FIG. 7 starts. When the information processing apparatus 1 is turned off, the execution of the process shown in FIG. 7 ends.

The order of the steps in the flowchart shown in this embodiment may be changed to the extent without contradiction. For instance, this disclosure illustrates various steps of the process using an example order, and the process is not limited to the order illustrated. The steps of the flowchart shown in this embodiment may be executed in parallel to the extent without contradiction.

As shown in FIG. 7, the processor 10 executes an initialization process (step S101). In the initialization process, various components are initialized. Variables also are initialized, including resetting of the buffer 11A.

The processor 10 executes the switch process (step S102). In the switch process, the operational states of various manipulation elements on the switch panel 15 are obtained. For instance, information such as volume information and tone information are acquired.

The processor 10 executes the functional process (step S103). In the functional process, the functions corresponding to the operational status of the various manipulation elements obtained in step S102 are executed. For instance, when a music playback start button is pressed, a music playback start process is executed. When a song selection button is pressed, the selected music data 13A is loaded from the flash memory 13 into the RAM 11.

The processor 10 executes the music progression process (step S104). In the music progression process, the song progresses as time passes.

The processor 10 executes the performance operation process (step S105). In the performance operation process, while MIDI data D corresponding to the user's performance operation is input from the electronic musical instrument 2, the process corresponding to that performance operation is executed.

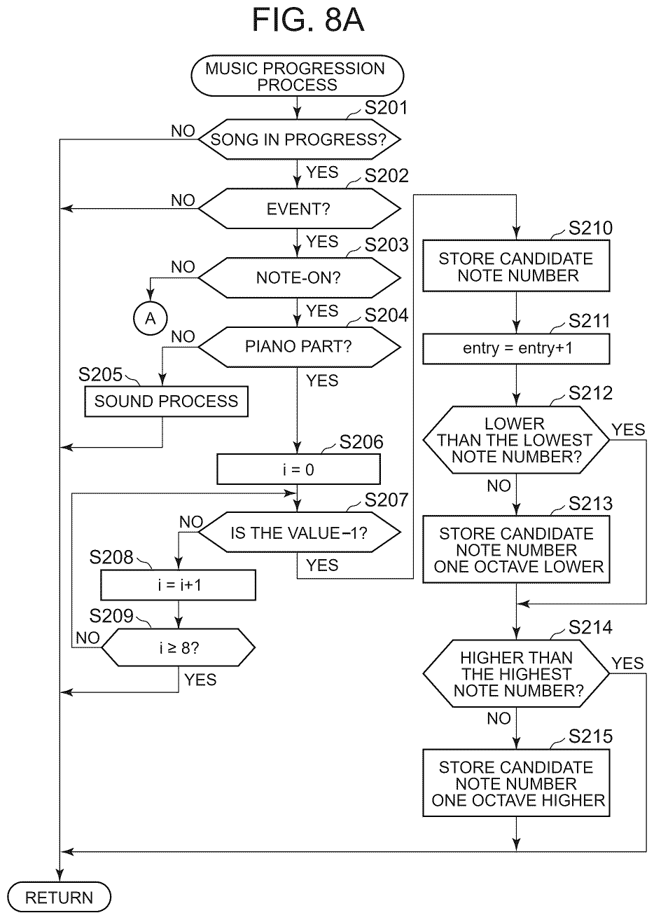

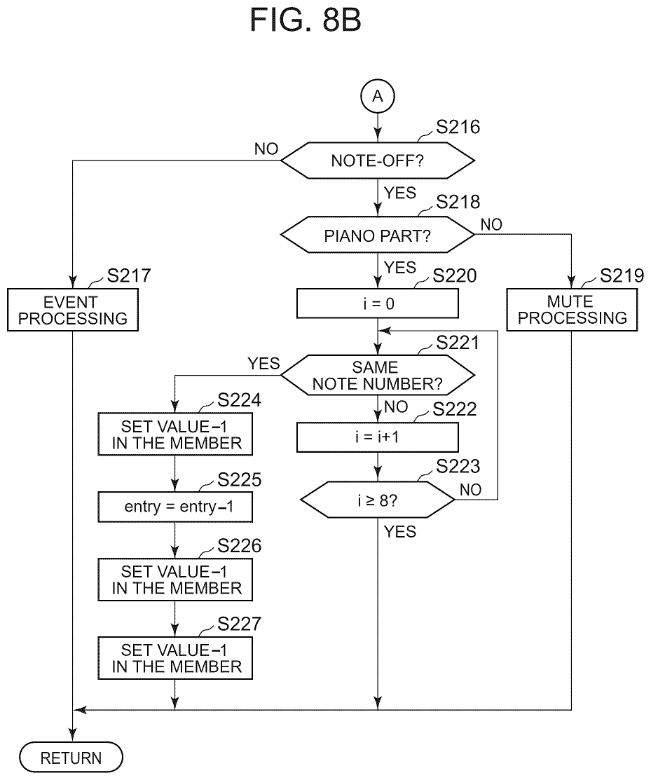

Referring to FIG. 8A and FIG. 8B, the following describes a subroutine for the music progression process in step S104 in FIG. 7. In this music progression process, the processor 10 automatically advances the non-performing parts, but does not automatically advance the performing part. For the performing part, the processor 10 updates the buffer 11A as needed in accordance with note events included in the music data 13A so that musical tones that are in musical harmony with the original pitch are produced and muted in response to keyboard operations. Note that even for the performing part, events other than note events (e.g., control change such as for pedals) are processed according to the description of events in the music data 13A.

As shown in FIG. 8A, the processor 10 determines whether a song is in progress (step S201). A song is in progress if the user has pressed the music playback start button and has not pressed the music playback stop button or the song has not finished. If the song is not in progress (step S201: NO), the processor 10 ends the subroutine.

When a song is in progress (step S201: YES), the processor 10 determines whether or not there is an event to be processed in the current progress time (step S202). If there are no events to be processed (step S202: NO), the processor 10 ends the subroutine.

If there is an event to be processed (step S202: YES), the processor 10 determines whether this event is a note-on event (step S203). If the event is a note-on event for a non-performing part (other than the piano part, which is the performing part in this example) (step S203: YES, step S204: NO), the processor 10 processes the sounding of the musical tones of the non-performing part according to the event description (step S205) and ends this subroutine. That is, the processor 10 automatically advances the non-performing part.

If the event to be processed is a note-on event for a performing part (in this case, the piano part) (step S203: YES, step S204: YES), the processor 10 sets the value of variable i to 0 (step S206). Variable i indicates the index of the array.

The processor 10 determines whether the values of the note member and the on note member of the i-th element of the region note_buf_mid are −1 (step S207). If the values of the note member and the on note member are −1, it indicates that the element is empty. If the note member has a value other than −1, the candidate note number is set. If the on_note member is a value other than −1, the musical tone of the sounding note number is in the state of being sounded.

If at least one of the values of the note member and the on note member of the i-th element of the region note_buf_mid is not −1 (step S207: NO), the processor 10 increments variable i by 1 to proceed to the search for the next element (step S208). If variable i is equal to or greater than the number of elements in the region note_buf_mid (NOTES_NUM=8) (step S209: YES), there is no empty element. Therefore, the processor 10 ends this subroutine. The processor 10 repeats the processes of steps S207 to S209 until an empty element is found.

If the i-th element is empty (step S207: YES), the processor 10 stores the note number described in the note-on event of the performing part as a candidate note number in the note member of the i-th element (step S210). The processor 10 increments variable entry by 1 (step S211). Variable entry indicates the total number of candidate note numbers stored in the note member of the elements of the region “note_buf_mid”. Variable entry is initialized to value 0 in the initialization process (step S101 in FIG. 7) The processor 10 also stores in the buffer 11A the candidate note numbers one octave lower and one octave higher of the original pitch (steps S212 to S215).

Specifically, the processor 10 determines whether the value obtained by subtracting 12 from the candidate note number stored in step S210 is lower than the lowest note number (note number 21 corresponding to pitch A0) (step S212). If the value is equal to or greater than the lowest note number (step S212: NO), the value by subtraction indicates a note number within the key range. Thus, the processor 10 stores the candidate note number one octave lower (i.e., the value obtained by subtracting 12 from the candidate note number stored in step S210) in the note member of the i-th element of the region note_buf_lower (step S213). If the value by subtraction is lower than the lowest note number (step S212: YES), it is out of the key range. In this case, the processor 10 executes the process of step S214 without executing the process of step S213.

In step S214, the processor 10 determines whether the value obtained by adding 12 to the candidate note number stored in step S210 is higher than the highest note number (note number 108 corresponding to pitch C8) (step S214). If the value is equal to or less than the highest note number (step S214: NO), the value by addition indicates a note number within the key range. Thus, the processor 10 stores the candidate note number one octave higher (i.e., the value obtained by adding 12 to the candidate note number stored in step S210) in the note member of the i-th element of the region note_buf_upper (step S215). If the value by addition exceeds the highest note number (step S214: YES), it is out of the key range. In this case, the processor 10 does not execute the process of step S215, and ends this subroutine.

For instance, consider a case where the sound source LSI 17 is capable of producing musical tones with note numbers (0 to 127) including those outside the key range. In this case, the processor 10 may store, as candidate note numbers, the candidate note numbers that are one octave lower and one octave higher in the buffer 11A, even if they are outside the key range.

In this manner, this embodiment is configured to store sounding candidate notes one octave higher and lower of one sounding candidate note (musical tone of the original pitch) in the buffer 11A. The number of sounding candidate notes is increased by three times, so that this embodiment avoids a shortage in the number of candidate pitches when selecting musical tones to be sounded in response to key pressing operations.

If the event to be processed is not a note-on event (step S203: NO), the processor 10 determines whether this event is a note-off event (step S216). If it is not a note-off event (step S216: NO), the processor 10 executes an event process such as a control change according to the description of the event (step S217), and ends this subroutine.

If the event to be processed is a note-off event of a non-performing part (step S216: YES, step S218: NO), the processor 10 processes the muting of the musical tone of the non-performing part in accordance with the description of the event (step S219), and ends this subroutine. That is, the processor 10 automatically advances the non-performing part.

If the event to be processed is a note-off event for the performing part (step S216: YES, step S218: YES), the processor 10 sets the value of variable i to 0 (step S220).

The processor 10 determines whether the candidate note number stored in the note member of the i-th element of the region note_buf_mid is the same as the note number described in the note-off event of the performing part (step S221).

If the candidate note number is different from the note number described in the note-off event (step S221: NO), the processor 10 increments variable i by 1 to proceed to the next element (step S222). If variable i is less than the number of elements in the region note_buf_mid (NOTES_NUM=8) (step S223: NO), the processor 10 returns to the process of step S221. If variable i is equal to or greater than the number of elements (NOTES_NUM) in the region note_buf_mid (step S223: YES), the candidate note number that is the same as the note number described in the note-off event has been deleted. Thus, the processor 10 ends this subroutine.

If the candidate note number is the same as the note number described in the note-off event (step S221: YES), it indicates that the timing has come to mute the musical tone of this candidate note number in the performing part. Thus, the processor 10 sets the value of the note member of the i-th element of the region note_buf_mid to −1 (step S224). The processor 10 decrements variable entry by 1 (step S225).

The processor 10 also deletes candidate note numbers one octave higher and lower of the candidate note number deleted in step S224 (steps S226 and S227). Specifically, the processor 10 sets the value of the note member of the i-th element in the region_note_buf_lower to −1 (step S226) The processor 10 sets the value of the note member of the i-th element in the region note_buf_upper to −1 (step S227).

The event to be processed is the note-off event of the performing part, and thus the value of the on note member is not changed, as explained referring to FIG. 6. Therefore, even after the candidate note number is deleted, the musical tone corresponding to the sounding note number continues to be sounded. This allows the user to play the performing part with a musical tone that reflects their intention.

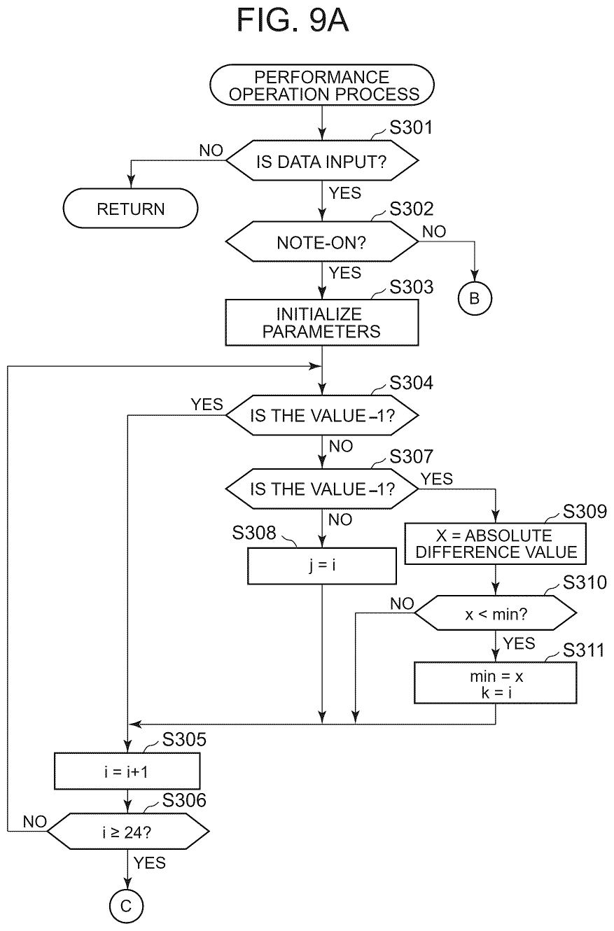

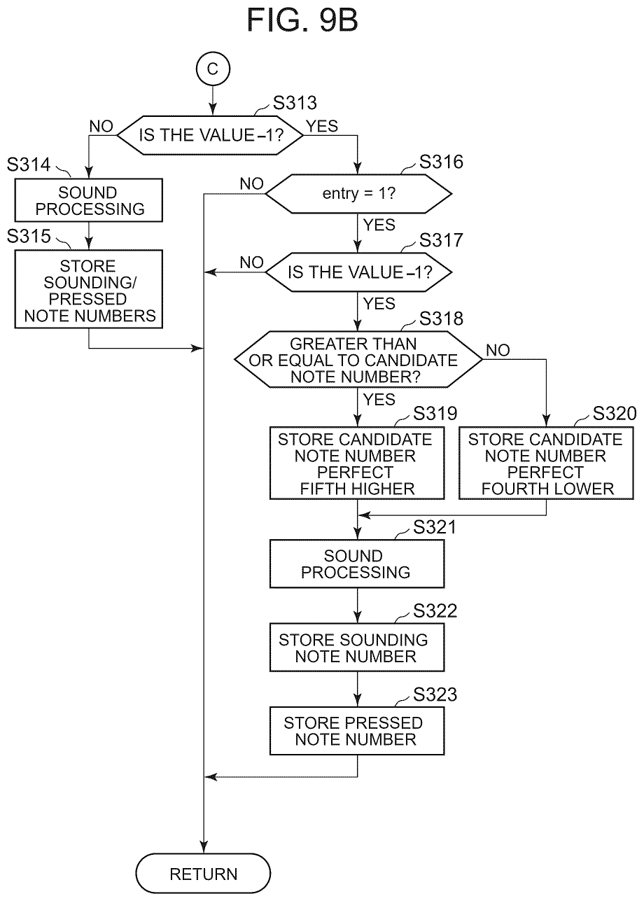

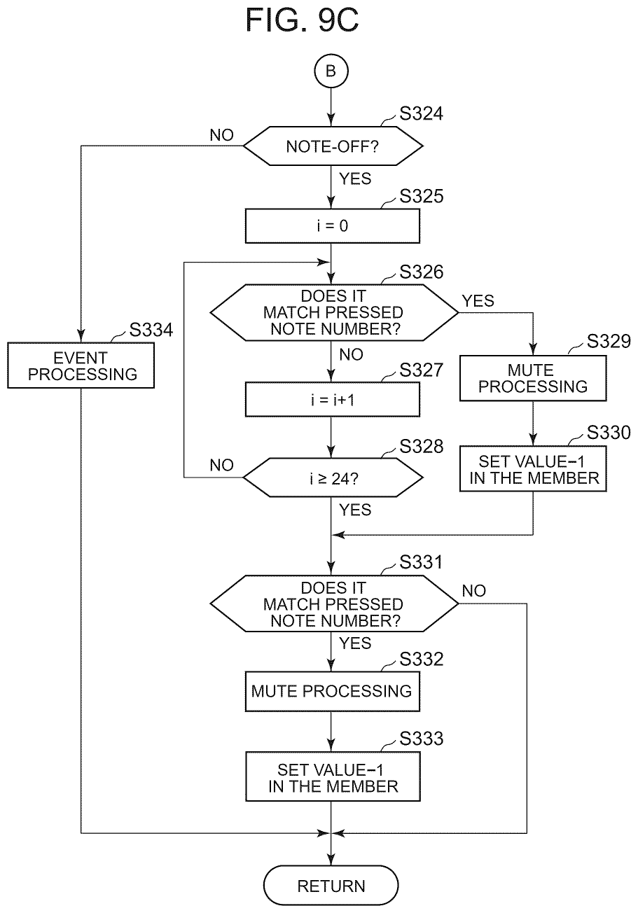

Referring to FIG. 9A through FIG. 9C, the following describes a subroutine for the performance operation process in step S105 in FIG. 7. In this performance operation process, the processor 10 performs a process for the performing part in accordance with the performance operation. When the performance operation is on the keyboard, the processor 10 processes the sounding and muting of musical tones that are musically in harmony with the original pitch on the basis of the note numbers stored in the buffer 11A.

The performance operation process is executed periodically, for example, every 1 ms. This means that while the user presses multiple keys, a sounding note number is selected sequentially from among a plurality of candidate note numbers, and the musical tone of the selected sounding note number is sounded sequentially. As a result, musical tones in the same number as the pressed keys are produced in a musically harmonious manner. In this embodiment, the number of sounding candidate notes is increased, which avoids a shortage in the number of candidate pitches when selecting musical tones to be sounded in response to key pressing operations.

As shown in FIG. 9A, the processor 10 determines whether MIDI data D has been input in response to the performance operation (step S301). If no MIDI data D is input (step S301: NO), the processor 10 ends this subroutine.

If a note-on event corresponding to a key pressing operation is input (step S301: YES, S302: YES), the processor 10 initializes various parameters (step S303). Specifically, the processor 10 sets the value of variable i to 0. The processor 10 sets variables j and k to value −1, indicating invalid status. The processor 10 sets the value of variable min to 999.

Variable j indicates an index of the array, and is used when processing the sounding of a musical tone that is a perfect fifth higher or a perfect fourth lower. Variable k indicates an index of the array, and is used when processing the sounding of musical tones of the original pitch or its one octave higher and lower. Variable min indicates the absolute difference value between the candidate note number and the pressed note number.

The processor 10 determines whether the value stored in the note member of the i-th element of the region note_buf is −1 (step S304). The region note_buf is the area where the regions note_buf_lower, note_buf_mid, and note_buf_upper are connected. The “note_buf” is a pointer variable that indicates the start of the entire buffer 11A.

If the value stored in the note member of the element is −1 (step S304: YES), no candidate note number is stored in the note member of the element. The processor 10 increments variable i by 1 to proceed to the next element (step S305). If variable i is greater than or equal to the number of elements in the entire buffer 11A (NOTES_NUM_ALL=24) (step S306: YES), this means that the processor 10 has searched all elements of the array, and the processor 10 proceeds to step S313. If an unsearched element remains (step S306: NO), the processor 10 returns to the process of step S304.

If the value stored in the note member of the element is not −1 (step S304: NO), a candidate note number is stored in the note member of the element. The processor 10 determines whether the value stored in the on note member of the element is −1 or not (step S307).

If the value stored in the on note member of the element is not −1 (step S307: NO), a sounding note number is stored in the on note member of the element. That is, the musical tone of the sounding note number stored in the on note member of the element is being sounded. The processor 10 sets the value of variable i to variable j to indicate that this musical tone is being sounded (step S308). The processor 10 proceeds to step S305 to proceed to the next element.

If the value stored in the on note member of the element is −1 (step S307: YES), a sounding note number is not stored in the on note member of the element. That is, the musical tone of the candidate note number stored in the note member of the element is not yet sounded. The processor 10 sets the absolute difference value between this candidate note number and the pressed note number to variable x (step S309).

The processor 10 determines whether variable x is less than variable min (step S310). If variable x is greater than or equal to variable min (step S310: NO), a candidate note number with a smaller absolute difference value from the pressed note number has already been detected. The processor 10 proceeds to step S305 to proceed to the next element.

If variable x is less than variable min (step S310: YES), the absolute difference value between the candidate note number stored in the note member of the element and the pressed note number is the smallest at the present time. Thus, the processor 10 updates the value of variable min to the value of variable x (step S311). The initial value of variable min is 999, while the maximum value of the note number is 127. Therefore, if there is an unsound candidate note number, the value of variable min is always updated to the value of variable x.

In step S311, the processor 10 sets the value of variable i to variable k. When the search of all the elements in the array is completed, the value of variable k indicates the element i (i-th element) in which the candidate note number having the smallest absolute difference value from the pressed note number is stored. For convenience, this element is referred to as “element k.”

In step S313, the processor 10 determines whether variable k is the initial value −1. If variable k is not value −1 (step S313: NO), the processor 10 processes the sounding (step S314). Specifically, the processor 10 instructs the sound source LSI 17 to produce the musical tone of the candidate note number stored in the note member of element k at the velocity at which the key is pressed (step S314). The processor 10 stores the candidate note number stored in the note member of element k as the sounding note number in the on note member of element k, and stores the pressed note number in the on_key member of element k (step S315). The processor 10 ends this subroutine.

This embodiment is configured to search the entire buffer 11A from the top, and from among the candidate pitches (the pitch one octave lower of the original pitch, the original pitch, and the pitch one octave higher of the original pitch), produce a musical tone of the candidate pitch closest to the operated pitch. Thus, the higher the key range the user presses, the more likely the musical tone of a high candidate pitch will be sounded, and the lower the key range the user presses, the more likely the musical tone of a low candidate pitch will be sounded. This allows the user to play the performing part with the musical tone of a pitch that reflects their intention.

If variable k is value −1 (step S313: YES), all of the musical tones of the candidate note numbers (original pitch and pitches one octave higher and lower) are being sounded. Currently, there are no musical tones of candidate note numbers that can be newly sounded. In this case, the processor 10 executes the processes from step S316 onwards to try to add a new candidate pitch that is musically in harmony with the original pitch.

Specifically, the processor 10 tries to add a pitch that is of a perfect interval (i.e., a perfect fifth higher or a perfect fourth lower of the candidate pitch being sounded) as a new candidate pitch. These candidate pitches are in musical harmony with the musical tone being sounded, regardless of the key of the song. “A perfect fourth lower of the candidate pitch being sounded” can be rephrased as “a perfect fifth higher of the pitch one octave lower of the candidate pitch being sounded.”

In step S316, the processor 10 determines whether variable entry is value 1. If variable entry is value 1 (step S316: YES), the total number of candidate note numbers stored in the note member of the element in the region note_buf_mid is one. That is, the number of musical tones of the original pitch is one, and musical tones of all candidate note numbers are being sounded (i.e., the first candidate pitch and all second candidate pitches corresponding to the single pitch are being sounded). Here, the buffer 11B is a buffer dedicated to perfect intervals, and has the same data type as the buffer 11A. If the variable entry is value 1 (step S316: YES), the processor 10 determines whether the value stored in the note member of the buffer 11B is −1 (step S317).

If the value stored in the note member of the buffer 11B is −1 (step S317: YES), the musical tone of perfect interval is not being sounded. In this case, the processor 10 determines whether the pressed note number is greater than or equal to the candidate note number stored in the note member of the j-th element of the region note_buf (step S318). The j-th element contains the largest candidate note number among the candidate note numbers. Basically, the j-th element stores the candidate note number one octave higher of the original pitch. In the case where one octave higher of the original pitch is out of key, the j-th element stores the candidate note number of the original pitch. For convenience, the candidate note number stored in the note member of the j-th element of the region note_buf is written as “candidate note number (j)”.

If the pressed note number is equal to or greater than the candidate note number (j) (step S318: YES), the processor 10 adds value 7 to the candidate note number (j). This added value indicates a candidate note number a perfect fifth higher of the candidate note number (j). The processor 10 stores the candidate note number that is the perfect fifth higher in the note member of the buffer 11B (step S319). In some cases, a note number outside the key range (109 and above) is stored as a candidate note number that is a perfect fifth higher.

If the pressed note number is less than the candidate note number (j) (step S318: NO), the processor 10 subtracts value 5 from the candidate note number (j). This subtraction value indicates a candidate note number that is a perfect fourth lower of the candidate note number (j). The processor 10 stores the candidate note number that is the perfect fourth lower in the note member of the buffer 11B (step S320).

The processor 10 instructs the sound source LSI 17 to produce the musical tone of the candidate note number stored in the note member in the buffer 11B, which is a perfect fifth higher or a perfect fourth lower, at the velocity at which the key is pressed (step S321). The processor 10 stores the candidate note number of the musical tone to be sounded by the instruction as the sounding note number in the on note member of the buffer 11B (step S322). The processor 10 further stores the pressed note number in the on key member of the buffer 11B (step S323). The processor 10 ends this subroutine.

In this way, adding pitches of perfect intervals as candidate pitches further prevents a shortage of candidate pitches when selecting a musical tone to be sounded in response to a key pressing operation, and also ensures musical harmony.

If variable entry is not value 1 (step S316: NO), then the original pitch has two or more musical tones, or the original pitch does not exist at all. If the number of musical tones of the original pitch is two or more, there is concern about dissonance, as described above. Thus, the processor 10 ends this subroutine. If the value stored in the note member of the buffer 11B is not −1 (step S317: NO), the musical tone of perfect interval is already being sounded. In this case also, the processor 10 ends this subroutine.

If an event other than a note event (e.g., a control change such as for a pedal) is input (steps S301: YES, S302: NO, S324: YES), the processor 10 processes the event according to the description (step S334). If a note-off event in response to a key release operation is input (step S301: YES, S302: NO, S324: YES), the processor 10 proceeds to the process of step S325.

In step S325, the processor 10 sets the value of variable i to 0 to search for a note-off target. The processor 10 determines whether the pressed note number stored in the on key member of the i-th element of the region note_buf matches the released note number included in the note-off event (step S326). If they do not match (step S326: NO), the processor 10 increments variable i by 1 to proceed to the next element (step S327). If variable i is greater than or equal to the number of elements in the entire buffer 11A (NOTES_NUM_ALL=24) (step S328: YES), this means that the processor 10 has searched all elements of the array, and the processor 10 proceeds to step S331. If an unsearched element remains (step S328: NO), the processor 10 returns to the process of step S326.

If an element storing the pressed note number that matches the released note number is found (step S326: YES), the processor 10 processes the muting (step S329). Specifically, the processor 10 instructs the sound source LSI 17 to mute the musical tone of the sounding note number stored in the on_note member of the element (step S329). The processor 10 sets the values of the on note and on key members of the element to −1 (step S330). This causes the status of these members to transition to an invalid state. In contrast, the note member of the element is not transitioned to the invalid state. Until the note member is transitioned to the invalid state in step S224 of FIG. 8B, the musical tone of the candidate note number stored in the note member may be sounded again in response to a key press operation.

The processor 10 determines whether the pressed note number stored in the on key member in the buffer 11B matches the released note number included in the note-off event (step S331). If they do not match (step S331: NO), the processor 10 ends this subroutine. If they match (step S331: YES), the processor 10 instructs the sound source LSI 17 to mute the musical tone of the sounding note number stored in the on_note member of the buffer 11B (step S332). The processor 10 sets the values of the note member, on note member, and on_key member of the buffer 11B to −1 (step S333) and ends this subroutine.

In this embodiment, when the number of musical tone for the original pitch is one and all of the candidate note numbers are being sounded, the pitch of perfect interval is added as a new candidate pitch. In another embodiment where the key of a song can be acquired, a note of third that matches the key may be added as a new candidate pitch, instead of or in addition to the pitch of perfect interval.

Pitches a perfect fourth higher and a perfect fifth lower also harmonize well. In this embodiment, therefore, the pitch of perfect interval is not limited to a pitch that is a perfect fifth higher or a perfect fourth lower of the candidate pitch (the original pitch or a pitch one octave higher or lower of the original pitch), but may also be a pitch that is a perfect fourth higher or a perfect fifth lower of the candidate pitch. That is, a pitch of a perfect interval, which is an example of the third candidate pitch, includes at least one of a pitch that is a perfect fifth higher or a perfect fourth lower of the first candidate pitch, a pitch that is a perfect fifth higher or a perfect fourth lower of the second candidate pitch, a pitch that is a perfect fourth higher or a perfect fifth lower of the first candidate pitch, and a pitch that is a perfect fourth higher or a perfect fifth lower of the second candidate pitch.

The following describes modified example 1 of the present disclosure. In the above embodiment, a sounding candidate note is set in accordance with a note event of the performing part. In modified example 1, in addition to such a sounding candidate note, another sounding candidate note is set on the basis of a chord event.

A chord event is registered in the music data 13A in accordance with the timing of a chord change. For instance, it is a meta event describing a chord-name character string. The chord-name character string is text data (an example of the data of a chord) indicating the chords such as C, CM7, and Cm7.

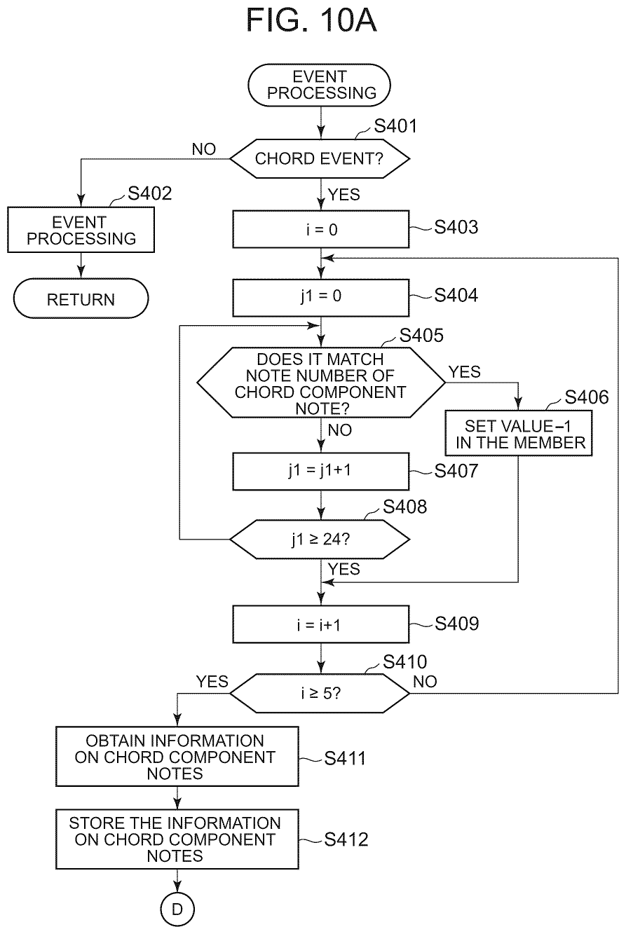

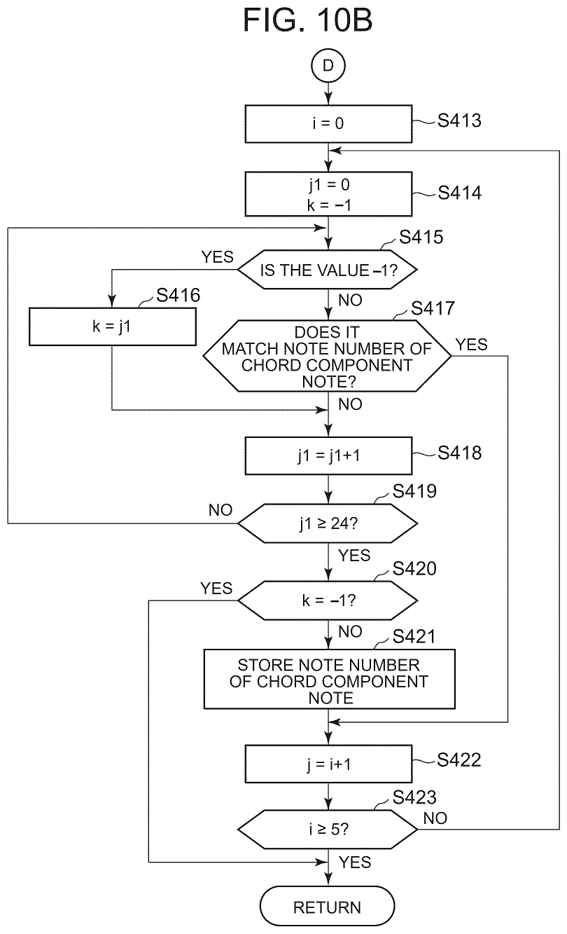

Referring to FIG. 10A and FIG. 10B, the following describes event processing according to modified example 1 of the present disclosure. FIG. 10A and FIG. 10B show a modified example of the event processing (step S217 in FIG. 8B) of the above embodiment. The processing according to modified example 1 is the same as that of the above embodiment except for this event processing.

As shown in FIG. 10A, the processor 10 determines whether it is a chord event (step S401). If it is not a chord event (step S401: NO), the processor 10 executes an event process such as a control change according to the description of the event (step S402), and ends this subroutine. If it is a chord event (step S401: YES), a chord change occurs at this timing. Thus, the processor 10 first deletes from the note member of the buffer 11A the note number of the chord component note stored as a candidate note number during the previous chord event.

Specifically, the processor 10 sets element i and variable j1 to value 0 (step S403 and step S404). Here, variable i indicates the index of the array chord. Variable j1 indicates the index of the region note_buf in the buffer 11A. Array chord stores the note numbers of the chord component notes. The number of elements in chord array is 5 because it can accommodate a maximum of five chords.

The processor determines whether the value stored in the note member of the j1-th element of the region note_buf and the value of the i-th element of array chord (note number of the chord component note) match (step S405). If they match (step S405: YES), the processor 10 sets the value of the note member of the j1-th element to −1 (step S406). In other words, the processor 10 deletes the note number of the previous chord component note stored in the i-th element of array chord from the buffer 11A. The processor 10 increments variable i by 1 to proceed to the next element of array chord (step S409).

If they do not match (step S405: NO), the processor 10 increments variable j1i by 1 to proceed to the next element in the region note_buf (step S407). If variable j1 is less than the number of elements in the entire buffer 11A (NOTES_NUM_ALL=24) (step S408: NO), this means that there remains an unsearched element in the region note_buf for the i-th element of array chord. Thus, the processor 10 returns to step S405. If variable j1 is equal to or greater than the number of elements in the entire buffer 11A (step S408: YES), this means that the search of all the elements in the region note_buf is completed for the i-th element of array chord. The processor 10 increments variable i by 1 to proceed to the next element of array chord (step S409).

The processor 10 determines whether variable i is equal to or greater than value 5 (step S410). If variable i is less than value 5 (step S410: NO), there are still unprocessed elements in array chord. Thus, the processor 10 returns to step S404. If variable i is equal to or greater than value 5 (step S410: YES), this means that processing of all elements of array chord is complete. In other words, all chord component notes of the previous chord have been deleted from the note member in the buffer 11A.

The processor 10 obtains information on the chord component notes of a new chord from the chord-name character string described in the chord event in order to store the chord component notes of the new chord in the buffer 11A (step S411).

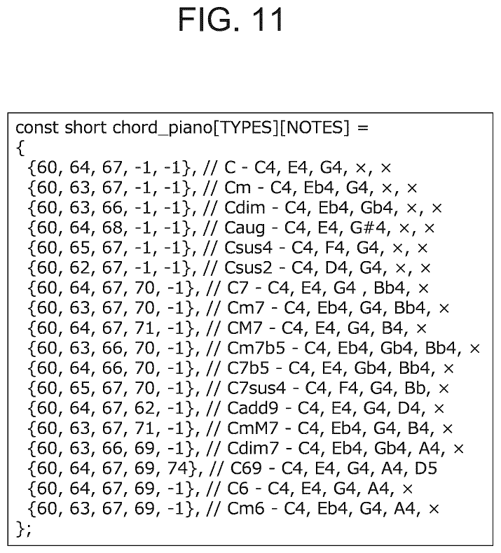

For instance, the flash memory 13 stores a chord table shown in FIG. 11. The chord table is a two-dimensional array having array chord (number of elements: 5) as an element. In the chord table, the chord type TYPES is the first index and the note NOTES is the second index.

The chord type TYPES has 18 elements to define 18 chord types. The chord type is extracted from the chord-name character string. For instance, value 0 indicates a chord type of major chord. Value 1 indicates a minor (n) chord type. Value 2 indicates a diminish (dim) chord type. Value 17 indicates a minor six (m6) chord type. Note NOTES indicates an element of array chord. The value stored in array chord indicates the note number. An element that stores value −1 indicates an invalid sound.

The chord table holds information on the chord component notes of a chord whose root note is C. The root note is pitch C4. For instance, for a C chord (i.e., the chord type with value 0), the elements of array chord hold {60, 64, 67, −1, −1}. For a Cm chord (i.e., the chord type with value 1), the elements of array chord hold {60, 63, 67, −1, −1}. For convenience, a chord whose root note is C will be referred to as a “C root chord.”

The processor 10 adds the difference between the C root chord and a chord other than the C root chord to the chord component notes of the C root chord, thereby obtaining elements of array chord for the chord other than the C root chord. For instance, in the case of a C♯ root chord whose root note is C♯, one semitone higher of C, the additive value is 1. Thus, for the C♯ chord, {61, 65, 68, −1, −1}will be obtained as elements of the array chord. In the case of an A root chord, whose root note is A, nine semitone higher of C, the additive value is 9. Thus, for the Am7 chord, {69, 72, 76, 79, −1}will be obtained as elements of the array chord.

In a more specific example, the processor 10 first provisionally obtains a difference value from the first character of the chord-name character string. For instance, the case of Am7 chord will be described. In this case, the first character is “A.” C chord is 9 semitones higher of A chord, and thus the processor 10 provisionally obtains value 9 as the difference value. If the second character is “♯”, the processor 10 increases the difference value by one semitone to value 10. If the second character is “♭”, the processor 10 decreases the difference value by one semitone to value 8. In the case of “Am7”, the second character is “m”, indicating the chord type. Thus, the processor 10 determines the difference value to be 9.

If the second character is “m”, the chord type is one of m, m7, m7b5, mM7, and m6. The third character of “Am7” is “7,” and thus the chord types are narrowed down to m7 and m7b5. The fourth character of “Am7” is a null character that terminates the character string. Thus, the processor 10 determines the chord type to be 7, corresponding to “m7”. The processor adds the difference value 9 to the elements {60, 63, 67, 70, −1}, which correspond to the chord type value 7, to obtain the elements {69, 72, 76, 79, −1}.

The processor 10 stores the information on the chord component notes of the chord obtained in step S411 (i.e., the elements indicating the note numbers of the chord component notes) in array chord (step S412).

The processor 10 adds as candidate note numbers those elements of array chord (i.e., the note numbers of the chord component notes) that are not currently stored as candidate note numbers in the note member.

Specifically, the processor 10 sets the value of variable i to 0 (step S413). The processor 10 sets the value of variable j1 to 0 and the value of variable k to −1 (step S414).

The processor 10 determines whether the value stored in the note member of the j1-th element of the region note_buf is −1 (step S415). If it is value −1 (step S415: YES), the processor 10 sets the value of variable j1 to variable k (step S416) to indicate that the element is empty, and proceeds to step S418.

If it is not value −1 (step S415: NO), the processor 10 determines whether the candidate note number stored in the note member of the element matches the note number of the chord component note stored in the i-th element of chord array (step S417). If they match (step S417: YES), the note number of the chord component note has already been stored as the candidate note number. In this case, the processor 10 increments variable i by 1 to proceed to the next element of array chord (step S422).

If they do not match (step S417: NO), the processor 10 increments variable j1 by 1 to proceed to the next element in the region note_buf (step S418). If variable j1 is less than the number of elements in the entire buffer 11A (NOTES_NUM_ALL=24) (step S419: NO), this means that there remains an unsearched element in the region note_buf. Thus, the processor 10 returns to step S415.

If variable j1 is equal to or greater than the number of elements in the entire buffer 11A (step S419: YES), the note number of the chord component note stored in the i-th element of chord array is not stored in the buffer 11A as a candidate note number. The processor 10 then determines whether variable k remains at the initial value of −1 (step S420).

If variable k is not value −1 (step S420: NO), there is an empty element in the region note_buf in which a candidate note number can be stored. Thus, the processor 10 stores the note number of the chord component note stored in the i-th element of chord array as a candidate note number in the note member of the empty element indicated by variable k (step S421). The processor 10 increments variable i by 1 to proceed to the next element of array chord (step S422).

The processor 10 determines whether variable i is equal to or greater than value 5 (step S423). If variable i is less than value 5 (step S423: NO), there are still unprocessed elements in array chord. Thus, the processor 10 returns to step S414. If variable i is equal to or greater than value 5 (step S423: YES), this means that processing of all elements of the array chord is complete. Thus, the processor 10 ends this subroutine.

If variable k is value −1 (step S420: YES), the candidate note number is stored in the note member of all elements in the region note_buf and there are no empty elements. In this case, the processor 10 ends this subroutine without newly storing the note number of the chord component note as a candidate note number.

In this way, modified example 1 is configured to add the pitch of the chord component note of the ongoing chord as a candidate pitch. This further avoids a shortage of candidate pitches when selecting a musical tone to be sounded in response to a key pressing operation, and also ensures musical harmony.

The root note set in the chord table is not limited to pitch C4. In another embodiment, a pitch that is far from the range that constitutes the melody may be set as the root note. In this case, the range that constitutes the melody and the range of the chord component note are separated. This allows the user to clearly distinguish between the melody and accompaniment in their performance expression, for example.

The following describes modified example 2 of the present disclosure. While the above embodiments have one performing part, modified example 2 may have multiple performing parts. The following describes a case of two performing parts, a piano part and an obbligato part. In another modified example, the process described below may be performed for three or more performing parts.

Modified example 2 is configured to store note numbers of the pitches of musical tones of the two performing parts (i.e., the original pitches) in the buffer 11A as candidate note numbers. Note that the musical tone sounded in accordance with the candidate note number is the tone of one specific performing part (e.g., piano part), regardless of the performing part of the original pitch.

For instance, each candidate note number may be associated with a performing part, whereby the musical tone of each candidate note number can be produced with the tone of the original performing part. In this case, however, it is difficult for the user to predict which tone will be produced in response to the key pressing operation. Therefore, it is considered easier to achieve a natural performance sound if the tones of the musical tones sounded in response to key pressing operations are unified into a single tone.

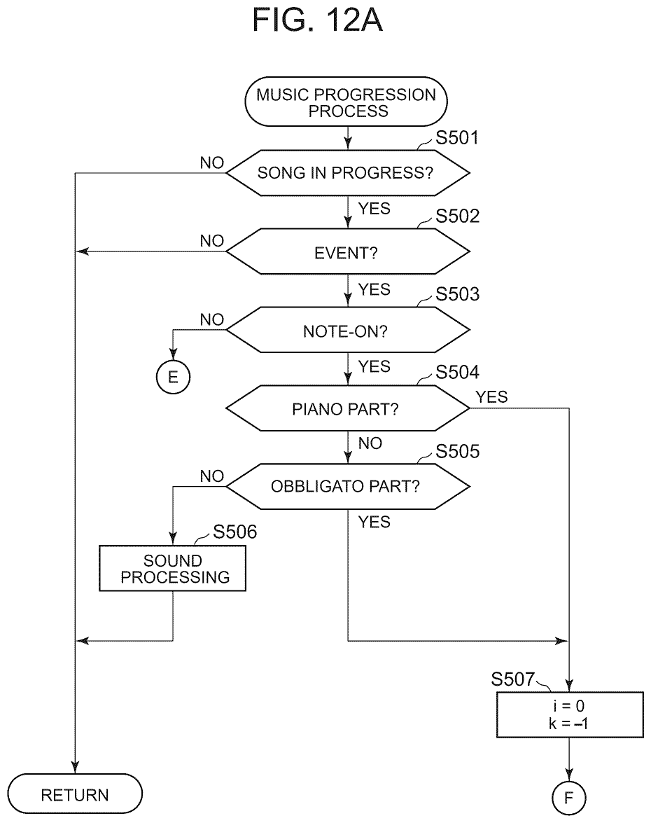

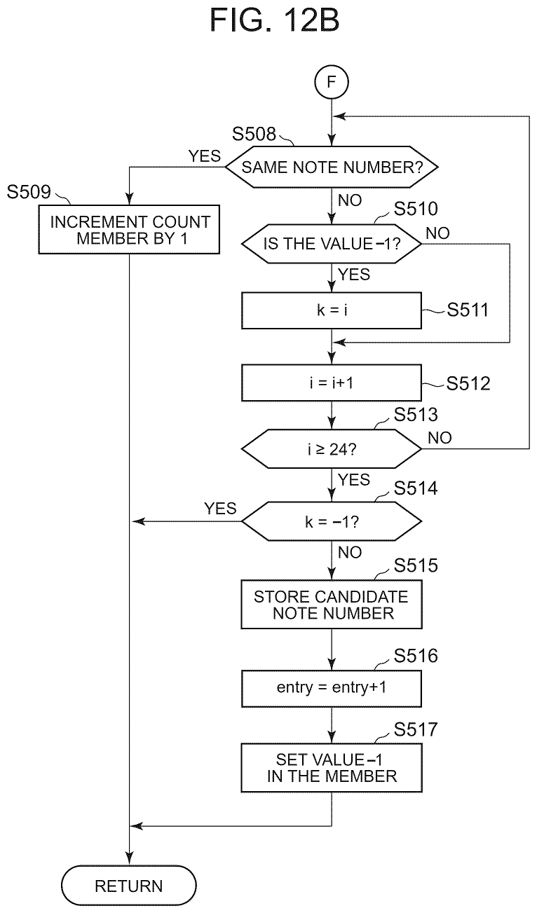

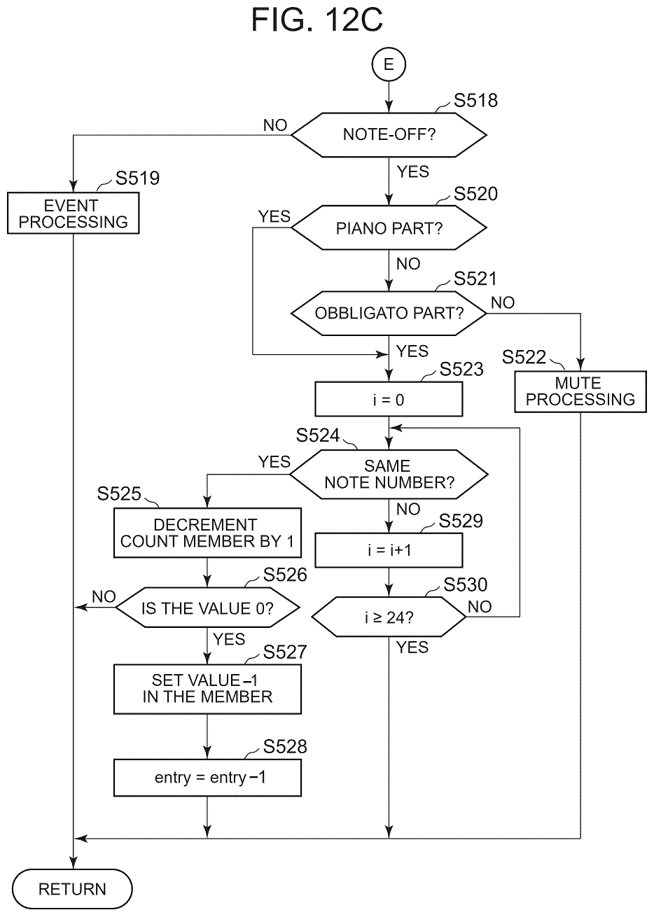

Referring to FIG. 12A through FIG. 12C, the following describes music progression processing according to modified example 2 of the present disclosure. FIG. 12A through FIG. 12C show a modified example of the music progression processing of the above embodiment (step S104 in FIG. 7). The processing according to modified example 2 is the same as in the above embodiment, except for this music progression processing.

As shown in FIG. 12A, like steps S201 to S204 in FIG. 8A, the processor 10 performs music progression determination (step S501), event presence determination (step S502), note-on event determination (step S503), and performing part (piano part) determination (step S504). In modified example 2, the processor 10 further performs a performing-part (obbligato part) determination (step S505). If the event to be processed is a note-on event for a non-performing part (step S505: NO), the processor 10 processes the sounding of the musical tone for the non-performing part according to the event description (step S506) and ends this subroutine.

If the event to be processed is a note-on event for a performing part (in this case, the piano part or obbligato part) (step S504: YES or step S505: YES), the processor 10 sets the value of variable i to 0 and sets the value of variable k to −1 (step S507).

The processor 10 determines whether the value stored in the note member of the i-th element of the region note_buf is the same as the note number included in the note-on event of the performing part (step S508). If the value stored in the note member of this element is the same as the note number included in the note-on event of the performing part (step S508: YES), the processor 10 increments the value of count member of the element by 1 (step S509), and ends this subroutine.

In modified example 2, the data type of the buffer 11A has the count member added as a member variable to the above embodiment. For the count member, the number of musical tones of the same pitch, which is the number of musical tones in the sounding period on the song data 13A, is stored. For instance, if a musical tone of pitch C3 is being sounded only in the piano part on the music data 13A, the value stored in the count member for pitch C3 is 1. If a musical tone of pitch C3 is being sounded in the piano part and the obbligato part on the music data 13A, the value stored in the count member for pitch C3 is 2.

In this way, when a note number included in a new note-on event of a performing part is stored in the buffer 11A as a candidate note number, the processor 10 counts up the value of count member without newly storing this candidate note number in the buffer 11A. Thus, the same note number is not stored multiple times as a candidate note number in the buffer 11A. Therefore, even if the user presses multiple keys, musical tones of the same pitch will not be produced simultaneously.

With acoustic instruments, even when the same pitch is played with the same strength, the pitch fluctuates differently each time, and the waveform of the musical tone will not be the same. For this reason, when multiple tones of the same pitch are played together, such as when multiple violins are played in an orchestra, for example, the fluctuating sounds will influence each other, creating a rich chorus effect. In contrast, electronic musical instruments reproduce musical tones using the waveform data stored in the memory. If the tones are the same, playing the same pitch and with the same strength will reproduce the same waveform of musical tones. When musical tones of the same pitch are played simultaneously, this is not desirable because it can result in the volume simply increasing or an unnatural undulation being produced.

The sounding periods of musical tones of the same pitch may overlap between the two performing parts. In modified example 2, the processing is performed for two performing parts. Thus, a situation may occur in which two musical tones with overlapping sounding periods or the same pitch are sounded simultaneously. To avoid this situation, the processor 10 does not store the same note number as the already stored candidate note number as a new candidate note number.

If the value stored in the note member of the element is different from the note number included in the note-on event of the performing part (step S508:NO), the processor 10 determines whether the note member of the element is empty (step S510). Specifically, the processor 10 determines whether the value stored in the note member of the element is −1.

If it is empty (step S510: YES), the processor 10 sets the value of variable i to variable k (step S511), and increments variable i by 1 (step S512). If it is not empty (step S510: NO), the processor 10 increments variable i by 1 without processing step S511 (step S512).

If variable i is greater than or equal to the number of elements in the entire buffer 11A (NOTES_NUM_ALL=24) (step S513: YES), this means that the processor 10 has searched all elements of the array, and the processor 10 proceeds to step S514. If an unsearched element remains (step S513: NO), the processor 10 returns to the process of step S508.

If the process proceeds to step 514, the note number included in the note-on event of the performing part is not stored in the buffer 11A as a candidate note number. Then, in step S514, the processor 10 determines whether there is an empty element capable of storing the candidate note number. Specifically, the processor 10 determines whether variable k is value −1.

If variable k is not the value −1 (step S514: NO), there is an empty element in which a candidate note number can be stored. Thus, the processor 10 stores the note number included in the note-on event of the performing part as a candidate note number in the note member of the i-th element (step S515). The processor 10 increments variable entry by 1 (step S516).

At this time, the number of simultaneous sounding of the musical tone of the candidate note number stored in the note member in step S515 becomes 1. Thus, the processor 10 sets value 1 in the count member of the element (step S517). When setting value 1, the processor 10 ends this subroutine.

If the event to be processed is not a note-on event (step S503: NO), the processor 10 determines whether this event is a note-off event (step S518). If it is not a note-off event (step S518: NO), the processor 10 executes an event process such as a control change according to the description of the event (step S519), and ends this subroutine.

If the event to be processed is a note-off event (step S518: YES), the processor 10 determines whether the event is a note-off event of the performing part (piano part or obbligato part) (steps S520 and S521). If it is not a note-off event of the performing part (step S520: NO, step S521: NO), the processor 10 processes the muting of the musical tone of the non-performing part in accordance with the description of the event (step S522), and ends this subroutine. That is, the processor 10 automatically advances the non-performing part.

If it is a note-off event of the performing part (step S520: YES or Step S521: YES)), the processor 10 deletes the candidate note number corresponding to that note-off event from the buffer 11A.

Specifically, the processor 10 sets the value of variable i to 0 (step S523). The processor 10 determines whether the value stored in the note member of the i-th element of the region note_buf is the same as the note number included in the note-off event of the performing part (step S524). If the value stored in the note member of this element is the same as the note number included in the note-off event of the performing part (step S524: YES), the processor 10 decrements the value of count member of the element by 1 (step S525).

The processor 10 determines whether the value of count member of the element is 0 (step S526). If this value is 0 (step S526: YES), the musical tone of the note number included in the note-off event is not in the sounding period in any of the two performing parts. The processor 10 sets the value of the note member of the element to −1, which indicates an empty state (step S527). This causes the corresponding candidate note number to be deleted from the buffer 11A. The processor 10 decrements variable entry by 1 (step S528), and ends this subroutine.

If the value of count member of the element is not 0 (step S526: NO), the musical tone of the note number included in the note-off event is in the sounding period in the other performing part. In this case, the processor 10 ends this subroutine without deleting the corresponding candidate note number from the buffer 11A.

If the value stored in the note member of the element is different from the note number included in the note-off event of the performing part (step S524: NO), the processor 10 increments variable i by 1 (step S529) to proceed to the next element in the region note_buf. If the variable i is less than the number of elements in the entire buffer 11A (NOTES_NUM_ALL=24) (step S530: NO), this means that there remains an unsearched element in the region note_buf. Thus, the processor 10 returns to step S524. If the variable i is equal to or greater than the number of elements in the entire buffer 11A (step S530: YES), this means that the search of all the elements in the region note_buf is completed. Thus, the processor 10 ends this subroutine.

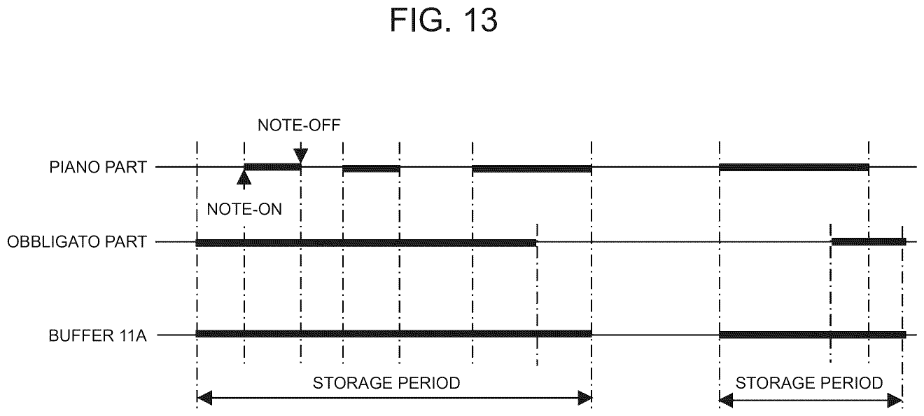

FIG. 13 shows the relationship between the period during which a musical tone of a certain pitch (e.g., pitch C4) is sounded in each performing part and the period during which the corresponding candidate note number (e.g., note number 60) is stored in the buffer 11A. For the “piano part” and “obbligato part” in FIG. 13, each period indicated by the thick line indicates the sounding period of the musical tone of pitch C4 (the period from note-on to note-off). For “buffer 11A” in FIG. 13, each period indicated by the thick line indicates the period during which note number 60 is stored as a candidate note number.

As shown in FIG. 13, in modified example 2, if a musical tone of pitch C4 is in the sounding period for one performing part, the note number 60 continues to be stored in the buffer 11A regardless of whether the sounding period of the musical tone of pitch C4 has ended in the other performing part. The storage period of the candidate note numbers is effectively lengthened. This means that the period during which a large number of candidate pitches are stored in the buffer 11A increases. This further avoids a shortage of candidate pitches when selecting a musical tone to be sounded in response to a key pressing operation.

The present disclosure is not limited to the above embodiments, and may be modified variously for implementation without departing from the scope of the invention. The functions performed in the embodiments may be combined for implementation as appropriate as possible. The embodiments include various steps, and various aspects of the invention can be extracted by combining a plurality of constituent elements in the disclosure. For example, some elements may be deleted from the constituent elements disclosed in the embodiments. Such a configuration after deletion also can be extracted as the invention as long as the configuration can have the advantageous effects as mentioned above. In a specific example, the embodiment described first may be combined with modified example 2, whereby the original pitches of multiple performing parts, pitches one octave higher and lower, and pitches of perfect intervals may all be set as candidate pitches in the music progression process.

The above embodiments describe a mode in which a song progresses automatically regardless of the presence or absence of a user's performance operation. The mode applicable to the information processing apparatus, method, and program according to the present embodiment is not limited to this. In another embodiment, a mode in which a song progresses only when the user performs a performance operation (i.e., a song does not progress unless the user performs a performance operation) may be applied to the information processing apparatus, method and program of this embodiment.

What is claimed is:

1. An information processing apparatus, comprising at least one processor,
the at least one processor being configured to
set a pitch of a musical tone in a sounding period on music data as a first candidate pitch, and set a second candidate pitch on a basis of the first candidate pitch,
detect an operated pitch associated with a manipulation element operated by a user,
on a basis of the detected operated pitch, select a sounding pitch of the musical tone from among a plurality of candidate pitches including the first and second candidate pitches, and
instruct a speaker to sound the musical tone with the selected sounding pitch.

2. The information processing apparatus according to claim 1, wherein
in a case that the user stops the operation to the manipulation element, the at least one processor mutes the musical tone with the sounding pitch regardless of whether the musical tone of the first candidate pitch is in the sounding period on the music data, and
in a case that the user keeps the operation to the manipulation element, the at least one processor continues to sound the musical tone with the sounding pitch.

3. The information processing apparatus according to claim 1, wherein
the second candidate pitch includes pitches that are one octave higher and one octave lower of the first candidate pitch.

4. The information processing apparatus according to claim 2, wherein
the second candidate pitch includes pitches that are one octave higher and one octave lower of the first candidate pitch.

5. The information processing apparatus according to claim 1, wherein
in a case that the musical tones of the first candidate pitch and the second candidate pitch are all being sounded and an operated pitch associated with the manipulation element operated by the user is further detected, the at least one processor sets a third candidate pitch.

6. The information processing apparatus according to claim 2, wherein
in a case that the musical tones of the first candidate pitch and the second candidate pitch are all being sounded and an operated pitch associated with the manipulation element operated by the user is further detected, the at least one processor sets a third candidate pitch.

7. The information processing apparatus according to claim 3, wherein
in a case that the musical tones of the first candidate pitch and the second candidate pitch are all being sounded and an operated pitch associated with the manipulation element operated by the user is further detected, the at least one processor sets a third candidate pitch.

8. The information processing apparatus according to claim 5, wherein
the third candidate pitch includes at least one of a pitch that is a perfect fifth higher or a perfect fourth lower of the first candidate pitch, a pitch that is a perfect fifth higher or a perfect fourth lower of the second candidate pitch, a pitch that is a perfect fourth higher or a perfect fifth lower of the first candidate pitch, and a pitch that is a perfect fourth higher or a perfect fifth lower of the second candidate pitch.

9. The information processing apparatus according to claim 1, wherein
the music data includes a plurality pieces of chord data changed as the music progress, and
the plurality of candidate pitches includes pitches of chord component notes corresponding to the chord data.

10. The information processing apparatus according to claim 1, wherein the at least one processor is configured to
determine a performing part from the music data in response to a user operation, and
set a pitch of a musical tone in a sounding period on data of the determined performing part as the first candidate pitch.

11. The information processing apparatus according to claim 1, wherein the at least one processor is configured to select, from among the plurality of candidate pitches, a candidate pitch, which is not a pitch of a musical tone being sounded and is closest to the operated pitch, as the sounding pitch.

12. A method that makes a computer execute the following steps of:
setting a pitch of a musical tone in a sounding period on music data as a first candidate pitch, and setting a second candidate pitch on a basis of the first candidate pitch,
detecting an operated pitch associated with a manipulation element operated by a user,
on a basis of the detected operated pitch, selecting a sounding pitch of the musical tone from among a plurality of candidate pitches including the first and second candidate pitches, and
instructing a speaker to sound the musical tone with the selected sounding pitch.

13. The method according to claim 12, wherein
in a case that the user stops the operation to the manipulation element, muting the musical tone with the sounding pitch regardless of whether the musical tone of the first candidate pitch is in the sounding period on the music data, and
in a case that the user keeps the operation to the manipulation element, continuing to sound the musical tone with the sounding pitch.

14. The method according to claim 12, wherein the second candidate pitch includes pitches that are one octave higher and one octave lower of the first candidate pitch.

15. The method according to claim 13, wherein the second candidate pitch includes pitches that are one octave higher and one octave lower of the first candidate pitch.

16. The method according to claim 12, wherein in a case that the musical tones of the first candidate pitch and the second candidate pitch are all being sounded and an operated pitch associated with the manipulation element operated by the user is further detected, setting a third candidate pitch.

17. The method according to claim 13, wherein in a case that the musical tones of the first candidate pitch and the second candidate pitch are all being sounded and an operated pitch associated with the manipulation element operated by the user is further detected, setting a third candidate pitch.

18. The method according to claim 14, wherein in a case that the musical tones of the first candidate pitch and the second candidate pitch are all being sounded and an operated pitch associated with the manipulation element operated by the user is further detected, setting a third candidate pitch.

19. A storage medium having stored thereon a computer program that makes a computer execute the following steps of:
setting a pitch of a musical tone in a sounding period on music data as a first candidate pitch, and setting a second candidate pitch on a basis of the first candidate pitch;
detecting an operated pitch associated with a manipulation element operated by a user; and
on a basis of the detected operated pitch, selecting a sounding pitch of the musical tone from among a plurality of candidate pitches including the first and second candidate pitches, and
instructing a speaker to sound the musical tone with the selected sounding pitch.
